(19) United States
(12) Patent Application Publication
(10) Pub. No.: US 2017/0198108 A1
(43) Pub. Date: Jul. 13, 2017

(54) PRODUCTION OF POLY ALPHA-1,3-GLUCAN FILMS

(71) Applicant: E I DU PONT DE NEMOURS AND COMPANY, Wilmington, DE (US)

(72) Inventors: Vindhya Mishra, Wilmington, DE (US); Debora Flanagan Massouda, Wilmington, DE (US); Colin Marshall, Wigton (GB); Jamie Moffat, Aspatria (GB)

(21) Appl. No.: 15/320,582

(22) PCT Filed: Jun. 25, 2015
(86) PCT No.: PCT/US15/37622

§ 371 Date: Dec. 20, 2016

Related U.S. Application Data
(60) Provisional application No. 62/017,469, filed on Jun. 26, 2014.

(51) Int. Cl. C08J 5/18

(52) U.S. Cl. CPC C08J 5/18; C08J 2305/00

(57) ABSTRACT

An extrusion process for making a poly alpha-1,3-glucan film is disclosed. These films can be translucent and used in packaging applications.

### CROSS-REFERENCE TO RELATED APPLICATION

This disclosure claims the benefit of priority of U.S. Provisional Application No. 62/017,469, filed on Jun. 26, 2014, the entirety of which is herein incorporated by reference.

### FIELD OF THE INVENTION

This invention relates to poly alpha-1,3-glucan films and methods of their preparation.

### BACKGROUND

Glucose-based polysaccharides and their derivatives can be of potential industrial application.

Cellulose is a typical example of such a polysaccharide and is comprised of beta-1,4-D-glycosidic linkages of hexopyranose units. Cellulose is used for several commercial applications such as in the manufacture of fibers and films. The cellulose used in such applications is typically derived from wood pulp, but may also be derived from pulps of cotton, flax, hemp or bamboo.

Dissolution of cellulose is a complex procedure. For cellulose film production, the most commonly used process for dissolving the cellulose is the ‘viscose process’. As those skilled in the art will be aware, the viscose process as generally practiced includes the steps of dissolving or slurrying a cellulose pulp in sodium hydroxide, steeping it in a sodium hydroxide solution, optionally mercersing the cellulose slurry to remove a portion of the sodium hydroxide solution, xanthating the cellulose with carbon disulfide, and re-dissolving it in an aqueous sodium hydroxide solution to form viscose i.e. a solution of cellulose xanthate.

The viscose is typically filtered and refiltered in order to maximise the purity of the material to improve product quality. It is then formed into a desired shape, for example a fiber or film, using techniques known to those skilled in the art, for example by extruding it through a slit or rollers to form a sheet of film, or by extruding it through a spinnerette to form a fibrous material. The shaped viscose is then contacted with an acidic casting solution to regenerate the cellulose from the viscose.

However, the viscose process has numerous disadvantages associated therewith, for example it involves the use of toxic chemicals, in particular carbon disulfide, and has significant environmental costs.

Another example of a glucose-based polysaccharide is a glucan polymer containing alpha-1,3-glycoside linkages. Glucan polymers have been shown to possess significant advantages, for example U.S. Pat. No. 7,000,000 describes a process for the preparation of a polysaccharide fiber comprising a polymer with hexose units, wherein at least 50% of the hexose units within the polymer are linked via alpha-1,3-glycoside linkages, and a number average degree of polymerization of at least 100. A glucosyltransferase enzyme from Streptococcus salivarius (gtfJ) is used to produce the polymer. The polymer formed a liquid crystal solution when it was dissolved above a critical concentration in a solvent or in a mixture comprising a solvent. From this solution continuous, strong, cotton-like fibers, highly suitable for use in textiles, were spun and used.

It would be desirable to manufacture films composed of a polysaccharide glucan polymer. It would also be desirable to manufacture films composed of a polysaccaride glucan polymer without using toxic chemicals, in particular carbon disulfide, in the process.

### SUMMARY

In a first embodiment, the disclosure concerns a process for making a poly alpha-1,3-glucan film comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film.

In a second embodiment, the disclosure concerns the solvent composition comprises an aqueous base.

In a third embodiment, the disclosure concerns the aqueous base is selected from the group consisting of aqueous potassium hydroxide, aqueous sodium hydroxide and aqueous tetraethyl ammonium hydroxide.

In a fourth embodiment, the disclosure concerns the concentration of the base in the solvent composition is: (a) from about 5 wt % to about 15 wt %; or (b) from about 7 wt % to about 13 wt %.

In a fifth embodiment, the disclosure concerns the solvent composition further comprises a solubility additive, a plasticizer additive or a mixture thereof.

In a sixth embodiment, the disclosure concerns the concentration of the poly alpha-1,3-glucan in the solution is in the range of: (a) from about 10 wt % to about 30 wt %; or (b) from about 15 wt % to about 23 wt %.

In a seventh embodiment, the disclosure concerns the coagulation bath comprises an aqueous acid or methanol.

In a eight embodiment, the disclosure concerns the aqueous acid comprises aqueous sulfuric acid.

In a ninth embodiment, the disclosure concerns the coagulation bath further comprises sodium sulfate, potassium sulfate, boric acid or a mixture of two or more thereof.

In a tenth embodiment, the disclosure concerns the film-shaped wet gel has a tensile strength of at least about 1.5 MPa, at least about 2.0 MPa or at least about 2.5 MPa.

In an eleventh embodiment, the disclosure concerns poly alpha-1,3-glucan film made according to a process for making a poly alpha-1,3-glucan film comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film.

In a twelfth embodiment, the disclosure concerns a film comprising poly alpha-1,3-glucan.

In a thirteenth embodiment, the disclosure concerns the film has at least one of: (a) a haze of less than about 10%, less than about 5% or less than about 3%; or (b) a breaking stress from about 10 to about 100 MPa.

In a fourteenth embodiment, the disclosure concerns a label, packaging article or security document comprising the film from the process for making a poly alpha-1,3-glucan film comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film.

In a fifteenth embodiment, the disclosure concerns the article labelled with or packaged by the label or packaging article.

### DETAILED DESCRIPTION

The disclosures of all patent and non-patent literature cited herein are incorporated herein by reference in their entirety.

As used herein, the term “invention” or “disclosed invention” is not meant to be limiting, but applies generally to any of the inventions defined in the claims or described herein. These terms are used interchangeably herein. Unless otherwise disclosed, the terms “a” and “an” as used herein are intended to encompass one or more (i.e., at least one) of a referenced feature.

The term “film” used herein refers to a thin, visually continuous material.

The term “packaging film” used herein refers to a thin, visually continuous material partially or completely surrounding an object.

The term “film shaped wet gel” used herein refers to the thin, visually continuous, coagulated form of the film-forming solution

The term “plasticizing” used herein refers the well-known effect of using an additive to achieve softening which involves at least one of (a) lowering of rigidity at room temperature; (b) lowering of temperature, at which substantial deformations can be effected with not too large forces or (c) increase of the elongation to break at room temperature.

The term “solvent composition” used herein refers to the mixture of compounds that are needed to dissolve a polymer.

The terms “poly alpha-1,3-glucan”, “alpha-1,3-glucan polymer”, “glucan polymer” and “glucan” are used interchangeably herein. Poly alpha-1,3-glucan is a polymer where the structure of poly alpha-1,3-glucan can be illustrated as follows (where n is 8 or more):

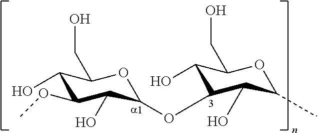

According to a first aspect of the present invention there is provided a process for making a poly alpha-1,3-glucan film, comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film.

Poly alpha-1,3-glucan may be prepared using chemical methods. Alternatively, poly alpha-1,3-glucan may be prepared by extracting it from various organisms, such as fungi, that produce poly alpha-1,3-glucan. Another alternative may be to enzymatically produce poly alpha-1,3-glucan from renewable resources, such as sucrose, for example using one or more glucosyl-transferase (e.g., gtfJ) enzyme catalysts found in microorganisms as described in the co-pending, commonly owned U.S. Patent Application Publication No. 2013/0244288 which is herein incorporated by reference in its entirety.

The poly alpha-1,3-glucan may have a degree of polymerisation (DPw) of at least about 400. Preferably, the poly alpha-1,3-glucan has a DPw of from about 400 to about 1400, or from about 400 to about 1000, or from about 500 to about 900.

In the process of the present invention, a solution of poly alpha-1,3-glucan is provided by dissolving poly alpha-1,3-glucan in a solvent composition. The solvent composition preferably comprises an aqueous base, which may comprise an aqueous alkali metal hydroxide, for example aqueous NaOH or aqueous KOH, and/or aqueous tetraethyl ammonium hydroxide. The aqueous base is preferably aqueous potassium hydroxide.

The concentration of the base in the solvent composition may be in the range of from about 4 wt % to about 20 wt %, preferably in the range of from about 5 wt % to about 15 wt % and most preferably in the range of from about 7 wt % to about 13 wt %. The concentration of the base in the solvent composition may depend on the DPw of the poly alpha-1,3-glucan used.

The solvent composition may further comprise one or more additives, for example a solubility additive, a plasticizer additive or a mixture thereof. The one or more additives may comprise alkoxylated alcohols e.g. ethoxylated alcohols, propylene glycols, polyethylene glycols, polyvinyl alcohols, polyacrylates, urea (CAS Registry Number: 57-13-6), and/or glycerol (CAS Registry Number: 56-81-5). Preferably, the solvent composition comprises urea which may act as a solubility additive, glycerol which may act as a plasticizer, or a mixture thereof. The urea may be added in any amount up to the weight of the poly alpha-1,3-glucan in the solution. The glycerol may be added in any suitable amount.

Poly alpha-1,3-glucan may be mixed with the solvent composition by the application of shear. In some instances, the poly alpha-1,3-glucan may be pre-mixed with water to form a slurry prior to mixing with the solvent composition. This may help to prevent clumping of the poly alpha-1,3-glucan during dissolution.

The concentration of the poly alpha-1,3-glucan in the resulting solution may be in the range of from about 10 wt % to about 30 wt % and preferably in the range of from about 15 wt % to about 23 wt %. Again, the concentration of the poly alpha-1,3-glucan in the solution may depend on the DPw of the poly alpha-1,3-glucan used.

For example, for a poly alpha-1,3-glucan with a DPw of about 850, the poly alpha-1,3-glucan concentration may be at least about 15 wt % and the concentration of aqueous potassium hydroxide may be at least about 8 wt %. For a poly alpha-1,3-glucan with a DPw of about 650, the poly alpha-1,3-glucan concentration may be at least about 17 wt % and the concentration of aqueous potassium hydroxide may be at least about 8 wt %. For a poly alpha-1,3-glucan with a DPw of about 550, the poly alpha-1,3-glucan concentration may be at least about 22 wt % and the aqueous potassium hydroxide may be at least about 11 wt %.

The inventors of the present invention have surprisingly found that a high concentration of poly alpha-1,3-glucan in the poly alpha-1,3-glucan solution, is required to produce an adequate strength film-shaped wet gel. More specifically, the film-shaped wet gel requires an adequate strength to endure tensioning arising from any subsequent film processing steps e.g. where the film is passed through rollers and/or baths to obtain desired optical and mechanical properties.

The inventors of the present invention have further found that these high concentration poly alpha-1,3-glucan solutions can be made using a high concentration of the basic solvent.

The solution of poly alpha-1,3-glucan is extruded into a coagulation bath to form a film-shaped wet gel. The coagulation bath may or may not have an air gap.

The coagulation bath may comprise an aqueous acid or methanol. The aqueous acid is preferably sulfuric acid. The aqueous acid or methanol may be present in the coagulation bath in an amount of from about 5 wt % to about 20 wt %, preferably from about 10 wt % to about 15 wt %.

The coagulation bath may further comprise sodium sulfate, potassium sulfate, boric acid or a mixture of two or more thereof. The sodium sulfate may be present in the coagulation bath in an amount of from about 10 wt % to about 40 wt %, preferably from about 20 wt % to about 30 wt %. The potassium sulfate may be present in the coagulation bath in an amount of from about 10 wt % to about 40 wt %, preferably from about 20 wt % to about 30 wt %. The boric acid may be present in the coagulation bath in an amount of from about 0.1 wt % to about 5 wt %, preferably from about 1 wt % to about 2 wt %.

The process of the present invention further involves the film-shaped wet gel being washed with water. The film-shaped wet gel may be washed with water until the bath has an approximately neutral pH i.e. pH 7.

The film-shaped wet gel may have a breaking stress of at least about 1.5 MPa, preferably at least about 2.0 MPa and more preferably at least about 2.5 MPa.

The water may be removed from the washed film-shaped wet gel through evaporation, for example at room temperature or at an elevated temperature, to provide the poly alpha-1,3-glucan film.

The resulting alpha-1,3-glucan film may have at least one of the following properties: (a) a haze of less than about 10%, less than about 5% or less than about 3%; and (b) a breaking stress of from about 10 to about 100 MPa. Advantageously, the alpha-1,3-glucan film formed using the process of the present invention has good optical properties, which may include a low haze.

The resulting alpha-1,3-glucan film may have a thickness of from about 10 μm to about 300 μm, from about 10 μm to about 200 μm, or from about 10 μm to about 100 μm.

Advantageously, the process of the present invention does not require the use of toxic chemicals, in particular carbon disulfide. In addition, fewer process steps are required to form the alpha-1,3-glucan film of the present invention compared to the conventional process for forming a cellulose film.

According to a second aspect of the present invention there is provided a film comprising poly alpha-1,3-glucan formed using the process of the first aspect of the present invention.

For the avoidance of doubt, all features of the first aspect of the invention also relate to the second aspect of the invention where appropriate, and vice versa.

The present disclosure is directed toward a process for making a poly alpha-1,3-glucan film comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film. The solvent composition can comprise an aqueous base. The aqueous base can be selected from the group consisting of aqueous potassium hydroxide, aqueous sodium hydroxide and aqueous tetraethyl ammonium hydroxide. The concentration of the base in the solvent composition can be: (a) from about 5 wt % to about 15 wt %; or (b) from about 7 wt % to about 13 wt %. The solvent composition can further comprise a solubility additive, a plasticizer additive or a mixture thereof. The concentration of the poly alpha-1,3-glucan in the solution can be in the range of: (a) from about 10 wt % to about 30 wt %; or (b) from about 15 wt % to about 23 wt %. The coagulation bath can comprise an aqueous acid or methanol. The aqueous acid can comprise aqueous sulfuric acid. The coagulation bath can further comprise sodium sulfate, potassium sulfate, boric acid or a mixture of two or more thereof. The film-shaped wet gel can have a tensile strength of at least about 1.5 MPa, at least about 2.0 MPa or at least about 2.5 MPa.

The present disclosure is further directed toward a poly alpha-1,3-glucan film made by a process comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film.

The present disclosure is still further directed toward a film comprising poly alpha-1,3-glucan. The film has at least one of: (a) a haze of less than about 10%, less than about 5% or less than about 3%; or (b) a breaking stress from about 10 to about 100 MPa.

The present disclosure is still further directed toward a label, packaging article or security document comprising the film made by a process comprising: (a) dissolving poly alpha-1,3-glucan in a solvent composition to provide a solution of poly alpha-1,3-glucan; (b) extruding the solution of poly alpha-1,3-glucan into a coagulation bath to make a film-shaped wet gel; (c) washing the film-shaped wet gel with water; (d) optionally, plasticizing the film-shaped wet gel with a plasticizer additive; and (e) removing the water from the film-shaped wet gel to form a poly alpha-1,3-glucan film. An article labelled with or packaged by the label or packaging article.

### EXAMPLES

The present disclosure is further exemplified in the following Examples. It should be understood that these Examples, while indicating certain preferred aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

The following abbreviations were used in the Examples

“DI water” is deionized water; “MPa” is megapascal; “NaOH” is sodium hydroxide; “KOH” is potassium hydroxide; “DPw” is weight average degree of polymerization, “l” is liter, “mm” is millimeter, “g” is gram, “min” is minute.

### General Methods

Degree of Polymerization (DPw) and Polydispersity Index (PDI) were determined by size exclusion chromatography (SEC). The molecular weight of a poly alpha-1,3-glucan can be measured as number-average molecular weight (Mₙ) or as weight-average molecular weight (M_{w}). The degree of polymerization can then be expressed as DP_{w} (weight average degree of polymerization) which is obtained by diving M_{w} of the polymer by the weight of the monomer unit, or DPₙ (number average degree of polymerization) which is obtained by dividing Mₙ of the polymer by the weight of the monomer unit. The chromatographic system used was Alliance™ 2695 liquid chromatograph from Waters Corporation (Milford, Mass.) coupled with three on-line detectors: differential refractometer 410 from Waters, multiangle light scattering photometer Heleos™ 8+ from Wyatt Technologies (Santa Barbara, Calif.) and differential capillary viscometer ViscoStar™ from Wyatt. The software packages used for data reduction were Empower™ version 3 from Waters (column calibration with broad glucan standard, DR detector only) and Astra version 6 from Wyatt (triple detection method without column calibration). Four SEC styrene-divinyl benzene columns from Shodex (Japan) were used—two linear KD-806M, KD-802 and KD-801 to improve resolution at low molecular weight region of a polymer distribution. The mobile phase was N,N′-Dimethyl Acetamide (DMAc) from J. T Baker, Phillipsburg, N.J. with 0.11% LiCl (Aldrich, Milwaukee, Wis.). The chromatographic conditions were as follows: Temperature at column and detector compartments: 50° C., temperature at sample and injector compartments: 40° C., flow rate: 0.5 ml/min, injection volume: 100 ul. The sample preparation targeted 0.5 mg/mL sample concentration in DMAc with 5% LiCl, shaking overnight at 100° C. After dissolution, polymer solution can be stored at room temperature.

Thickness of the film was determined using a Mitutoyo micrometer, No. 293-831.

Preparation for Tensile Testing

Dry films were measured with a ruler and 1″×3″ strips were cut using a comfort loop rotary cutter by Fiskars, No. 195210-1001. The samples were then transported to the testing lab where room conditions were 65% relative humidity and 70° F.+/−2° F. The sample weight was measured using a Mettler balance model AE240.

Film-shaped wet gels were cut into samples 1 inch wide and at least 2 inch long. The samples were measured with a ruler and 1″×3″ strips were cut using a comfort loop rotary cutter by Fiskars, No. 195210-1001. The samples were then transported to the testing lab in a water bath where room conditions were 65% relative humidity and 70° F.+/−2° F. The wet sample weight was measured using a Mettler balance model AE240. The sample was left to soak in the water bath till right before testing.

Tensile Properties were measured on an Instron 5500R Model 1122, using 1″ grips, and a 1″ gauge length, in accordance with ASTM D882-09.

Film Clarity and haze was determined using an Agilent (Varian) Cary 5000 uv/vis/nir spectrophotometer equipped with a DRA-2500 diffuse reflectance accessory in transmission mode. The DRA-2500 is a 150 mm integrating sphere with a Spectralon® coating. Total and diffuse transmission for the instrument and the samples are collected over the wavelength range of 830 nm to 360 nm. The calculations are made in accordance with ASTM D1003 using a 2 degree observer angle and illuminant C (represents average daylight, color temperature 6700K). Haze value was reported in percentage (%)

### Preparation of Poly Alpha-1,3-Glucan

Poly alpha-1,3-glucan, using a gtfJ enzyme preparation, was prepared as described in the co-pending, commonly owned U.S. Patent Application Publication Number 2013-0244288 which was published on Sep. 19, 2013, the disclosure of which is incorporated herein by reference.

### Materials

Potassium hydroxide, sodium hydroxide and sulfuric acid were obtained from EMD Chemicals (Billerica, Mass.). Glycerol was obtained from Acros Chemicals. Sodium sulfate was obtained from Sigma Aldrich.

### Solution Preparation

Solutions were mixed with either an IKA overhead stirrer and 1 inch plastic blade stirrer or with a high shear mixer. After thorough mixing, solutions were transferred to plastic centrifuge tubes and centrifuged using the Marathon 6K centrifuge by Fisher Scientific to de-aerate the solutions. Viscosity of the solution was measured using Brookfield Engineering laboratories Synchro-Lectric Viscometer, Model RVT.

### Example 1

### Process for Making a Poly Alpha-1,3-Glucan Film

Poly alpha-1,3-glucan polymer powder was dried in a vacuum oven at 40° C. overnight. 33 g poly alpha-1,3-glucan solid of DPw 800 was slurried in 50 g of water. 16.7 g of KOH was dissolved in 100 g of water. The KOH solution was then added to the alpha-1,3-glucan slurry and mixed using an air-powered overhead stirrer until the polymer was completely dissolved to make a solution of poly alpha-1,3-glucan. The solution was centrifuged for 30 minutes to remove air bubbles. The final solution concentration was 16.5 wt % poly alpha-1,3-glucan and 8.35 wt % KOH. The solvent composition defined as the weight of KOH divided by the weight of KOH and water was 10%. It should be noted that the alpha-1,3-glucan powder could be added directly to a 10% KOH solution in water. However, by first making a slurry of the solution of alpha-1,3-glucan before introducing the KOH solution, it helped to prevent clumping of the alpha-1,3-glucan. The solution of poly alpha-1,3-glucan was contacted onto a glass plate using a glass rod coater to form a film-like article. Film-like articles can also be cast using ChemInstruments Custom Coater EC-300 and standard casting rods such as a wire wound casting rod.

The solution of poly alpha-1,3-glucan and the glass plate were immersed in a coagulation bath of 13.75 wt % sulfuric acid, 26 wt % sodium sulfate and 1.25 wt % boric acid to make a film-shaped wet gel. The film-shaped wet gel was allowed to coagulate until it lifted off of the glass plate (about 1 minute). It should be noted that the solution of poly alpha-1,3-glucan can be extruded directly into the coagulation bath. The glass plate was used due to equipment limitations. The process steps used here were designed to mimic a direct extrusion process. The film-shaped wet gel was washed several times in fresh water baths until the pH of the water bath was neutral. The film-shaped wet gel thickness was measured to be 109 micron. The film was cut into 3 instron samples and breaking stress was measured. The average of the 3 measurements was breaking stress of 2.6 MPa and max strain to break of 70%. The film-shaped wet gel was allowed to dry on a glass plate under tension to constrain the film from shrinking while drying. The film-shaped wet gel dried to form a clear film. The haze value of the film was measured to be approximately 2.5%. Film preparation conditions and physical properties are summarized in the Table.

Thus, a poly alpha-1,3-glucan film was made according to the present disclosure.

### Examples 2 and 3

### Process for Making a Poly Alpha-1,3-Glucan Film Prepared from a Range of Poly Alpha-1,3-Glucan DPw Values

Examples 2 and 3 were prepared in a similar manner to Example 1 using alpha-1,3-glucan solutions with different DPw values and solution composition. Film preparation conditions and physical properties are summarized in the Table.

TABLE
Alpha-1,3-Glucan Film Preparation Conditions and Physical Properties

| | | | | Film-Like Wet Gel Physical | | | |
|---|---|---|---|---|---|---|---|
| | | | | Properties | | | |
| | | Glucan Solution | | | | Maximum | |
| | | Concentration | | | Breaking | Strain to | Dried |
| | Glucan | Glucan | KOH | Thickness | Stress | Break | Film |
| Example | DPw | (wt %) | (wt %) | (micron) | (MPa) | (%) | Clarity |
| 1 | 800 | 16.5 | 8.32 | 109 | 2.6 | 70 | Clear |
| 2 | 650 | 18 | 8.2 | 184 | 4.0 | 84 | Clear |
| 3 | 550 | 23 | 11.6 | 127 | 2.6 | 17 | Hazy |

Thus, Examples 1-3 demonstrate the solution compositions needed to make a poly alpha (1,3) glucan wet gel with wet gel strength above 2 MPa. While a film casting followed by coagulation process was used here for the purpose of demonstration, films with this wet gel strength should also be able to survive a film extrusion followed by coagulation process.

### Example 4

### Process for Making a Poly Alpha-1,3-Glucan Film

Sixty g of poly alpha-1,3-glucan mixture composed of 42% glucan of DPw 800 and 58% water was slurried in 50 g of water. 13.2 g of KOH was dissolved in 34.3 g of water. The KOH solution was then added to the alpha-1,3-glucan slurry and mixed using a lab-scale blender until the polymer was completely dissolved to make a solution of poly alpha-1,3-glucan. The solution was centrifuged for 30 minutes to remove air bubbles. The final solution concentration was 16 wt % poly alpha-1,3-glucan, 8.4 wt % KOH and 75.6% water. The solvent composition defined as the weight of KOH divided by the weight of KOH and water was 10%. The solution was extruded through a slot die directly into a coagulation bath. The slot dimensions were 254 micron in thickness and 19 mm in width. The solution was pumped through the slot die using a syringe pump with a cylinder volume of 100 ml. The slot die was slightly submerged into a coagulation bath during operation. The coagulation solution was composed of 14 wt % sulfuric acid, 22 wt % sodium sulfate and the rest water. The coagulation bath contained roughly 2 l of coagulation bath liquid in a 50 cm long stainless steel vat. The solution was pumped through the slot die and contacted with the coagulation liquid to make a film-shaped wet gel. The pump rate was varied from 2.5 ml/min to 10 ml/min. The wet gel was continuously pulled through the coagulation bath into a water bath. The film-shaped wet gel was washed several times in fresh water baths until the pH of the water bath was neutral. The film-shaped wet gel thickness was measured to be 102 micron. The film shaped wet gel was then dipped into a 3 wt % glycerol bath and then dried under tension. The film-shaped wet gel dried to form a clear film with breaking stress of 13 MPa and max strain to break of 40%.

Thus this Example demonstrates a process to make a glucan film by extruding the film into a coagulation bath to make a film-shaped wet gel that has sufficient strength to endure tensioning during the subsequent steps.

What is claimed is:

1. A process for making a poly alpha-1,3-glucan film comprising:
(a) dissolving poly alpha-1,3-glucan in a solvent composition to provide a solution of poly alpha-1,3-glucan;
(b) extruding the solution of poly alpha-1,3-glucan into a coagulation bath to make a film-shaped wet gel;
(c) washing the film-shaped wet gel with water;
(d) optionally, plasticizing the film-shaped wet gel with a plasticizer additive; and
(e) removing the water from the film-shaped wet gel to form a poly alpha-1,3-glucan film.

2. The process according to claim 1, wherein the solvent composition comprises an aqueous base.

3. The process according to claim 2, wherein the aqueous base is selected from the group consisting of aqueous potassium hydroxide, aqueous sodium hydroxide and aqueous tetraethyl ammonium hydroxide.

4. The process according to claim 1, wherein the concentration of the base in the solvent composition is:
(a) from about 5 wt % to about 15 wt %; or
(b) from about 7 wt % to about 13 wt %.

5. The process according to claim 1, wherein the solvent composition further comprises a solubility additive, a plasticizer additive or a mixture thereof.

6. The process according to claim 1, wherein the concentration of the poly alpha-1,3-glucan in the solution is in the range of:
(a) from about 10 wt % to about 30 wt %; or
(b) from about 15 wt % to about 23 wt %.

7. The process according to claim 1, wherein the coagulation bath comprises an aqueous acid or methanol.

8. The process according to claim 7, wherein the aqueous acid comprises aqueous sulfuric acid.

9. The process according to claim 7, wherein the coagulation bath further comprises sodium sulfate, potassium sulfate, boric acid or a mixture of two or more thereof.

10. The process according to claim 1, wherein the film-shaped wet gel has a tensile strength of at least about 1.5 MPa, at least about 2.0 MPa or at least about 2.5 MPa.

11. A poly alpha-1,3-glucan film made according to claim 1.

12. A film comprising poly alpha-1,3-glucan.

13. The film according to claim 12, wherein the film has at least one of:
(a) a haze of less than about 10%, less than about 5% or less than about 3%; or
(b) a breaking stress from about 10 to about 100 MPa.

14. A label, packaging article or security document comprising the film of claim 12.

15. An article labelled with or packaged by the label or packaging article of claim 14.
